(19) United States
(12) Patent Application Publication
(10) Pub. No.: US 2026/0029083 A1
(43) Pub. Date: Jan. 29, 2026

(54) PITCH-ADJUSTING COMPONENT FOR DISPLAY BRACKET AND DISPLAY BRACKET

(71) Applicant: Ningbo Tuotuo River Design Company, Ningbo (CN)

(72) Inventors: Xiaodong YOU, Ningbo (CN); Hongjun WANG, Ningbo (CN)

(73) Assignee: Ningbo Tuotuo River Design Company, Ningbo (CN)

(21) Appl. No.: 18/783,778

(22) Filed: Jul. 25, 2024

(51) Int. Cl. F16M 11/10; F16M 11/18

(52) U.S. Cl. CPC F16M 11/10; F16M 11/18; F16M 2200/06

(57) ABSTRACT

The present disclosure describes devices and systems of a pitch-adjusting assembly for display arms and a display arm. One pitch-adjusting assembly includes a fixing structure disposed on a support base; a mounting structure configured for mounting a display; and an adjusting structure penetrating the fixing structure, the adjustment structure comprising: an adjusting part, an elastic part disposed at the periphery of the adjusting part, and wherein: when the adjusting part drives the mounting structure to rotate from top to bottom, a first torque generated by the elastic part counteracts an overturning force generated by the display due to gravity to provide rotation resistance to the display; and when the adjusting part drives the mounting structure to rotate from bottom to top, a second torque released by the elastic part counteracts the overturning force generated by the display due to gravity to provide rotary power for the display.

### TECHNICAL FIELDS

The present disclosure relates to display mounting arm technology field, more specifically, a pitch-adjusting component for display bracket and a display bracket (or, a pitch-adjusting assembly for display arms and a display arm).

### BACKGROUND

A pitch-adjusting assembly for display arms is used for adjusting the pitch angle of the head of the display arm, and the adjustment and locking rely mostly on friction force. When a large weight display is attached to it, there are often situations where the display cannot stay still if the arm is locked purely by friction force. And even if it can be barely stopped, a great friction force will be required.

There are various issues/problems associated with some implementations. For example, when a user wants to adjust the pitch angle upwards (i.e. to make the display move from bottom to top) at this time, the upward force applied needs to overcome gravity and huge frictional force, resulting in a difficult adjustment and poor user experience.

The present disclosure provides various embodiments for providing a pitch-adjusting assembly for display arms and a display arm, addressing at least one issue/problem that display arms in the prior art are hard to adjust and do not have a good user experience as described above.

### SUMMARY

The present disclosure relates to methods, devices, and/or systems for providing a pitch-adjusting assembly for display arms and a display arm to solve the problem that display arms/display supporting products in the prior art are hard to adjust and do not have a good user experience.

To achieve the above purpose, the present disclosure describes a pitch-adjusting assembly for display arms, comprising a fixing structure configured to be disposed on a support base, a mounting structure configured for mounting a display, and an adjusting structure penetrating the fixing structure, the adjusting structure comprising: adjusting part, one end of the adjusting part is connected with the mounting structure, and the other end of the adjusting part is rotationally connected with the fixing structure; elastic part, the elastic part is located at the periphery of the adjusting part, one end of the elastic part is clamped or connected with the fixing structure, and the other end of the elastic part is clamped or connected with the adjusting part; wherein, when the adjusting part drives the mounting structure to rotate from top to bottom relative to the fixing structure, the torque generated by the elastic part counteracts the overturning force generated by the display due to gravity to provide rotation resistance for the display; when the adjusting part drives the mounting structure to rotate from bottom to top relative to the fixing structure, the torque released by the elastic part counteracts the overturning force generated by the display due to gravity to provide rotary power for the display.

Furthermore, at least one side of the fixing structure is provided with an assembly hole, the elastic part is a spiral torsion spring, and the spiral torsion spring is located inside the assembly hole.

Furthermore, a first clamping groove is set on the circumferential inner wall of the assembly hole, a second clamping groove is set on the circumferential outer wall of the adjusting part, the outer end of the spiral torsion spring is provided with a first clamping piece, which is in clamping fit with the first clamping groove, and the inner end of the spiral torsion spring is provided with a second clamping piece, which is in clamping fit with the second clamping groove.

The present disclosure describes another embodiments for providing a pitch-adjusting assembly for display arms, comprising a fixing structure, configured to be disposed on a support base; a mounting structure, configured for mounting a display; an adjusting structure, penetrating the fixing structure, and the adjusting structure comprising a rotating main body and an adjusting part rotatably arranged relative to the rotating main body, the adjusting part is connected with the mounting structure, the rotating main body drives the mounting structure to rotate unidirectionally from bottom to top relative to the fixed structure, the rotational resistance between the rotating main body and the fixing structure is smaller than the rotational resistance between the adjusting part and the rotating main body, so that the mounting structure rotates in a unidirectional and effortless manner from bottom to top.

Furthermore, the fixing structure is provided with an assembly through hole, the pitch-adjusting assembly further comprises a unidirectional effort-saving component located in the assembly through hole, and the unidirectional effort-saving component comprises: an outer shaft sleeve connected with the fixing structure or the outer shaft sleeve is in interference fit with the assembly through hole; the inner shaft sleeve is inside the outer shaft sleeve, the inner one is also located at the outer periphery of the rotating main body and it is meanwhile connected to it, and the inner shaft sleeve only rotates unidirectionally in the circumferential direction of the outer shaft sleeve relative to the outer shaft sleeve.

Furthermore, the adjustment part is provided with ribbed threads, the ribbed threads extend in the circumferential direction of the rotating main body, and from the rotating main body to the adjusting part, the width of the ribbed threads gradually increases. The rotating main body is provided with grooves matched with the ribbed threads, the grooves gradually increase in width from the rotating main body to the adjusting part, and the side walls of the ribbed threads are abutted against the inner walls of the grooves.

Furthermore, the ribbed threads are annular structure extending around the axis of the rotating main body; and/or, it can be a plurality of ribbed threads disposed along the adjusting part in a radial interval formation, and the rotating main body is provided with a plurality of grooves matched with the plurality of ribbed threads.

Furthermore, the rotating main body comprises a rotating shaft and a rotating part located at one end at least, of the rotating shaft, a rotational resistance exists between the adjusting part and the rotating part, a rotation stopping groove is set on the rotating part, and one end or the ends of the rotating shaft is/are in anti-rotating fit with the rotation stopping groove, so that the rotating part can drive the rotating shaft to rotate.

Furthermore, the mounting structure comprises: a panel for mounting a display; a connecting component, used for connecting the panel and the adjusting part, the connecting component is provided with a rotation stopping hole, and the adjusting part is in anti-rotating fit with the rotation stopping hole; or, the pitch-adjusting assembly further comprises a locking part penetrating the adjusting part and the rotating main body, and the locking part is used for locking the adjusting part on the rotating main body.

The present disclosure also describes various embodiments for providing a display arm, comprising a support base and a pitch-adjusting assembly for display arms, which is set on the support base.

By applying the technical scheme of this present disclosure, when the adjusting part drives the mounting structure to rotate from top to bottom relative to the fixing structure, the torque generated by the elastic part counteracts the overturning force generated by the display due to gravity to provide rotation resistance for the display; in this way, the torque generated by the elastic part can prevent the display from keeping moving downwards, in other words, the locking friction force between the adjusting part and the fixing structure, and the torque force generated by the elastic part are jointly used for preventing the display from moving, so that the position of the display can keep at the desired pitch angle after adjustment without requiring a great locking friction force.

When the adjusting part drives the mounting structure to rotate from bottom to top relative to the fixing structure, the torque released by the elastic part counteracts the overturning force generated by the display due to gravity to provide rotary power for the display, so that users can adjust the display upwards without overcoming great friction force and gravity, and also adjust the pitch angle of the display more effortlessly, improving user experience.

### BRIEF DESCRIPTION OF THE DRAWINGS

The system, device, product, and/or method described below may be better understood with reference to the following drawings and description of non-limiting and non-exhaustive embodiments. The components in the drawings are not necessarily to scale. Emphasis instead is placed upon illustrating the principles of the present disclosure.

FIG. 1 is an exploded structural diagram of the pitch-adjusting assembly for display arms of Embodiment 1 in the present disclosure.

FIG. 2 is a side section view of the pitch-adjusting assembly for display arms of Embodiment 1 in the present disclosure.

FIG. 3 is an exploded structural diagram of the fixing structure and the elastic part of the pitch-adjusting assembly for display arms in FIG. 1.

FIG. 4 is an exploded structural diagram of the adjusting part and the elastic part of the pitch-adjusting assembly for display arms in FIG. 1.

FIG. 5 is an exploded structural diagram of the pitch-adjusting assembly for display arms of Embodiment 2 in the present disclosure.

FIG. 6 is an exploded structural diagram in another direction of the pitch-adjusting assembly for display arms in FIG. 5.

FIG. 7 is a connecting structural diagram of the mounting structure and the adjusting part of the pitch-adjusting assembly for display arms in FIG. 5.

FIG. 8 is a side section view of the pitch-adjusting assembly for display arms of Embodiment 2 in the present disclosure.

Reference numbers and names in the drawings: 10. fixing structure; 11. assembly hole; 12. first clamping groove; 20. mounting structure; 21. panel; 22. connecting component; 30. rotating main body; 31. grooves; 32. rotating shaft; 33. rotating part; 34. rotation stopping groove; 50. adjusting part; 51. ribbed threads; 52. second clamping groove; 61. unidirectional effort-saving component; 62. locking part; 63. elastic part; 64. first clamping piece; 65. second clamping piece.

### DETAILED DESCRIPTION OF THE DISCLOSURE

The disclosed systems, devices, and methods will now be described in detail hereinafter with reference to the accompanied drawings that form a part of the present application and show, by way of illustration, examples of specific embodiments. The described systems and methods may, however, be embodied in a variety of different forms and, therefore, the claimed subject matter covered by this disclosure is intended to be construed as not being limited to any of the embodiments. This disclosure may be embodied as methods, devices, components, or systems. Accordingly, embodiments of the disclosed system and methods may, for example, take the form of hardware, software, or any combination thereof.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. It is intended, for example, that claimed subject matter may include combinations of exemplary embodiments in whole or in part. Moreover, the phrase “in one implementation”, “in another implementation”, “in some implementations”, or “in some other implementations” as used herein does not necessarily refer to the same implementation(s) or different implementation(s). It is intended, for example, that claimed subject matter may include combinations of the disclosed features from the implementations in whole or in part.

In general, terminology may be understood at least in part from usage in context. For example, terms, such as “and”, “or”, or “and/or,” as used herein may include a variety of meanings that may depend at least in part upon the context in which such terms are used. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various embodiments for providing a pitch-adjusting assembly for display arms and a display arm.

The pitch-adjusting assembly for display arms comprises a fixing structure, a mounting structure and an adjusting structure, wherein the adjusting structure comprises: one end of the adjusting part is connected with the mounting structure, and the other end of the adjusting part is rotationally connected with the fixing structure; the elastic part is located at the periphery of the adjusting part, one end of the elastic part is clamped or connected with the fixing structure, and the other end of the elastic part is clamped or connected with the adjusting part; when the adjusting part drives the mounting structure to rotate from top to bottom relative to the fixing structure, the torque generated by the elastic part counteracts the overturning force generated by the display due to gravity to provide rotation resistance for the display; when the adjusting part drives the mounting structure to rotate from bottom to top relative to the fixing structure, the torque released by the elastic part counteracts the overturning force generated by the display due to gravity to provide rotary power for the display.

The technical scheme of the present disclosure solves the problem that display arms in the prior art are hard to adjust and do not have a good user experience.

It should be noted that, in the case of no conflict, the features in one or more embodiments of the present disclosure may be combined with each other. The present disclosure will be described in detail below with reference to the drawings in conjunction with the embodiments.

It should be noted that, in the embodiments of the present disclosure, regardless of whether the mounting structure 20 rotates unidirectionally from bottom to top relative to the fixing structure 10 by the rotating main body 30, or the mounting structure 20 is driven by the adjusting part 50 to rotate relative to the fixing structure 10 from bottom to top or from top to bottom, reference is made that users face the front side of the display.

### Embodiment 1

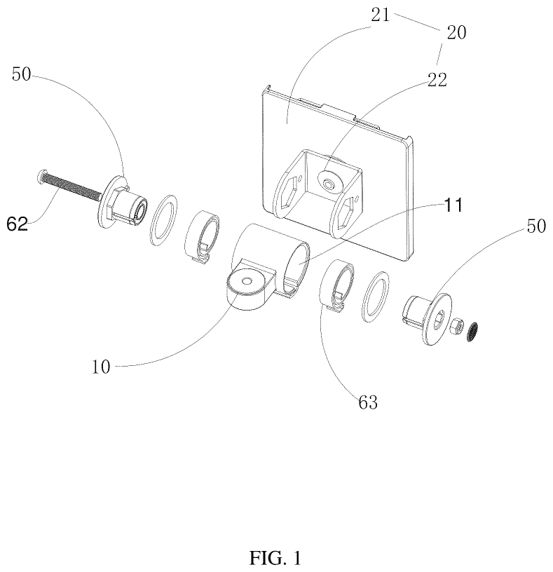

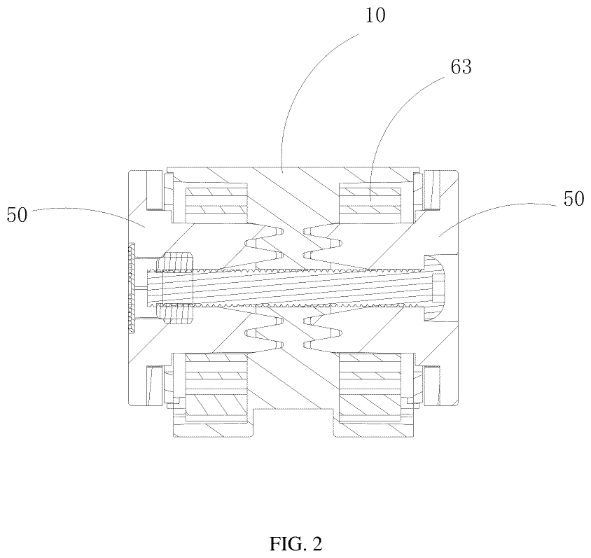

As shown in FIG. 1 to FIG. 4, the Embodiment 1 of the present disclosure provides a pitch-adjusting assembly for display arms.

The pitch-adjusting assembly for display arms comprises a fixing structure 10 configured to be disposed on a support base, a mounting structure 20 configured for mounting a display, and an adjusting structure penetrating the fixing structure 10, the adjustment structure comprising an adjusting part 50 and an elastic part 63.

In some implementations, one end of the adjusting part 50 is connected to the mounting structure 20, and the other end of the adjusting part 50 is rotationally connected to the fixing structure 10; the elastic part 63 is located at the periphery of the adjusting part 50, with one end of the elastic part 63 being clamped or connected with the fixing structure 10, the other end of the elastic part 63 being clamped or connected with the adjusting part 50.

In some implementations, when the adjusting part 50 drives the mounting structure 20 to rotate from top to bottom relative to the fixing structure 10, the torque generated by the elastic part 63 counteracts the overturning force generated by the display due to gravity to provide rotation resistance for the display.

In some implementations, when the adjusting part 50 drives the mounting structure 20 to rotate from bottom to top relative to the fixing structure 10, the torque released by the elastic part 63 counteracts the overturning force generated by the display due to gravity to provide rotary power for the display.

In the above technical scheme, when the adjusting part 50 drives the mounting structure 20 to rotate from top to bottom relative to the fixing structure 10, the torque generated by the elastic part 63 counteracts the overturning force generated by the display due to gravity to provide rotation resistance for the display; in this way, the torque generated by the elastic part 63 can prevent the display from keeping moving downwards, in other words, the locking friction force between the adjusting part 50 and the fixing structure 10, and the torque force generated by the elastic part 63 are jointly used for preventing the display from moving, so that the position of the display can keep at the desired pitch angle after adjustment without requiring a great locking friction force.

In some implementations, when the adjusting part 50 drives the mounting structure 20 to rotate from bottom to top relative to the fixing structure 10, the torque released by the elastic part 63 counteracts the overturning force generated by the display due to gravity to provide rotary power for the display, so that users can adjust the display upwards without overcoming great friction force and gravity, and also adjust the pitch angle of the display more effortlessly, improving user experience.

It should be noted that, in the embodiments of the present disclosure, the display is in an elevation position when it is installed on the display arm for the first time, so that when the pitch angle of the display is being adjusted, firstly the adjusting part 50 is made to drive the mounting structure 20 to rotate from top to bottom relative to the fixing structure 10, enabling the elastic part 63 to generate a torsion force, and then the adjusting part 50 drives the mounting structure 20 to rotate from bottom to top relative to the fixing structure 10 to release the torque generated by the elastic part 63.

It should be noted that, in the embodiments of the present disclosure, a locking friction force is generated between the adjusting part 50 and the fixing structure 10 to enable the display to hover at a desired position.

In some implementations, in the embodiments of the present disclosure, there are two adjusting parts 50, which are respectively located on two sides of the fixing structure 10, and the two adjusting parts 50 are both connected to the mounting structure 20.

As shown in FIG. 1 to FIG. 3, in the Embodiment 1 of the disclosure, at least one side of the fixing structure 10 is provided with an assembly hole 11, the elastic part 63 is a spiral torsion spring, and the spiral torsion spring is located inside the assembly hole 11.

In the above technical scheme, by adopting the spiral torsion spring, the size of the elastic part 63 in the axial direction of the adjusting part 63 can be reduced, and the spiral torsion spring can be placed in the assembly hole 11, so that the size of the whole pitch-adjusting assembly for display arms in the axial direction of the adjusting part 50 can be reduced, making the pitch-adjusting assembly for display arms in a more compact structure.

In some implementations, in the embodiments of the present disclosure, two sides of the fixing structure 10 are provided with assembly holes 11, there are two elastic parts 63, which are respectively located in the two assembly holes 11.

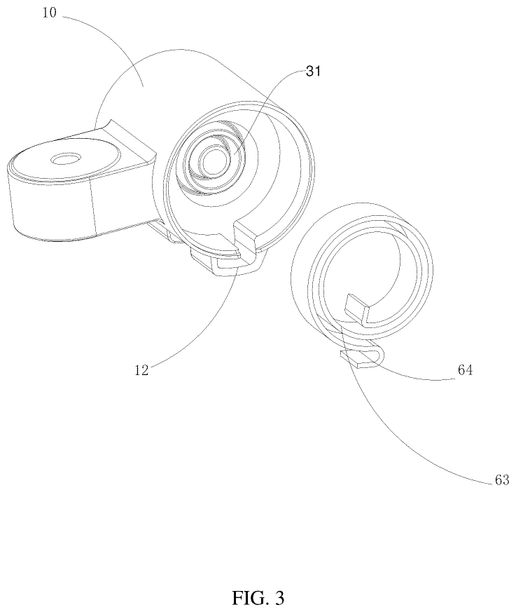

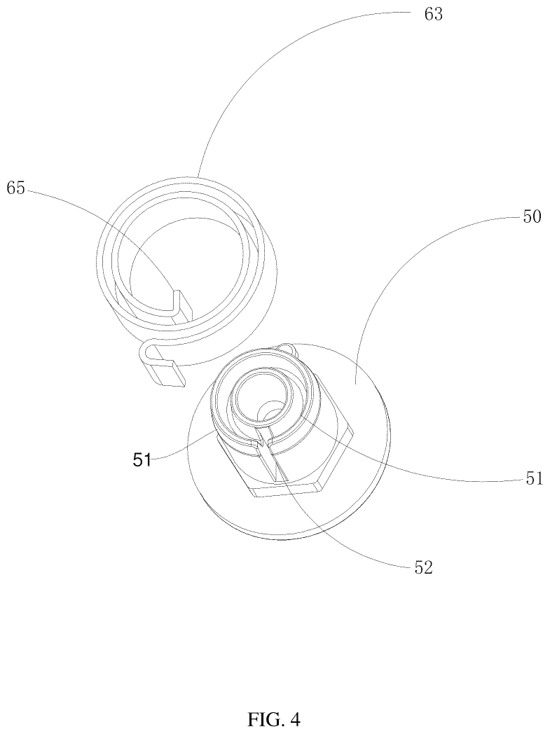

As shown in FIG. 3 and FIG. 4, in the Embodiment 1 of the present disclosure, a first clamping groove 12 is set on the circumferential inner wall of the assembly hole 11, a second clamping groove 52 is set on the circumferential outer wall of the adjusting part 50, the outer end of the spiral torsion spring is provided with a first clamping piece 64, which is in clamping fit with the first clamping groove 12, and the inner end of the spiral torsion spring is provided with a second clamping piece 65, which is in clamping fit with the second clamping groove 52.

Through the above arrangement, the outer end of the spiral torsion spring can be hooked on the fixing structure 10, and the inner end of the spiral torsion spring is hooked on the adjusting part 50, so that the adjusting part 50 rotates relative to the fixing structure 10, and when the display is adjusted from top to bottom (i.e. the adjusting part 50 in FIG. 1 rotates clockwise), the spiral torsion spring is stressed and generates a torque to prevent the adjusting part 50 from rotating, so that only a small locking friction force can make the display to hover at a desired pitch angle position; and when the display is adjusted from bottom to top (i.e., the adjusting part 50 in FIG. 1 rotates anticlockwise by viewing from right side towards left side of the figure), the spiral torsion spring can release the torque to provide power to the adjusting part 50, so that upward adjustment can be an effortless job.

As shown in FIG. 3 and FIG. 4, in Embodiment 1 of the present disclosure, the adjusting part 50 is provided with one or more rounds of threads (e.g., ribbed threads 51), the ribbed threads 51 extend in the circumferential direction of the adjusting part 50, and from the fixing structure 10 to the adjusting part 50, the widths of the ribbed threads 51 are gradually increases; The fixing structure 10 is provided with grooves 31 matched with the ribbed threads 51, the grooves 31 gradually increase in width from the fixing structure 10 to the adjusting part 50, and the side walls of the ribbed threads 51 are abutted against the inner walls of the grooves 31.

Through the above arrangement, on one hand, the adjusting part 50 and the fixing structure 10 can rotate relatively, and on the other hand, the friction force required for the display to hover can be generated between the side wall of the ribbed threads 51 and the inner wall of the grooves 31.

In some implementations, the ribbed threads 51 can be a conical structure, and the grooves 31 are conical grooves, so that the inclined side wall of the conical structure abuts against the inclined inner walls of the conical grooves, thereby a friction force can be generated.

In some implementations, as shown in FIG. 3 and FIG. 4, in Embodiment 1 of the present disclosure, the ribbed threads 51 are annular structure extending around the axis of the adjusting part 50; and the ribbed threads 51 are disposed along the adjusting part 50 in a radial interval formation, and the fixing structure 10 is provided with a plurality of grooves 31 matched with the plurality of ribbed threads 51.

Through the above arrangement, the friction force between the adjusting part 50 and the fixing structure 10 can be increased, thereby providing a great friction force for the display to hover and ensuring the stability of the display hovering at the desired position.

In some implementations, as shown in FIG. 1, in Embodiment 1 of the present disclosure, the mounting structure 20 comprises a panel 21 and a connecting component 22. Wherein, the panel is used for mounting a display; the connecting component 22 is used for connecting the panel 21 and the adjusting part 50, the connecting component 22 is provided with a rotation stopping hole, and the adjusting part 50 is in anti-rotating fit with the rotation stopping hole.

Through the above arrangement, the adjusting part 50 can drive the connecting component 22 to rotate when the adjusting part 50 is rotating, so that the display can be driven to rotate by the connected panel 21.

In some implementations, in Embodiment 1 of the present disclosure, the connecting component 22 is of a U-shaped structure, and the two ends of the U-shaped structure are respectively connected to the two adjusting parts 50. In this way, the display can be more stably mounted on the fixing structure 10.

In some implementations, in Embodiment 1 of the present disclosure, the connecting component 22 is riveted to the panel 21.

In some implementations, in Embodiment 1 of the present disclosure, the rotation stopping hole is a hexagonal hole, and some adjusting parts 50 are in hexagonal shape so as to achieve the anti-rotation fit.

In some implementations, as shown in FIG. 1, in Embodiment 1 of the present disclosure, the pitch-adjusting assembly further comprises a locking part 62 penetrating the adjusting part 50 and the fixing structure 10, and the locking part 62 is used for locking the adjusting part 50 on the fixing structure 10.

Through the above arrangement, the locking force provided by the locking part 62 can squeeze and abut the side wall of the ribbed threads 51 with the inner wall of the grooves 31, so that the friction force required for the display to hover is generated between the side wall of the ribbed threads 51 and the inner wall of the grooves 31.

In some implementations, in Embodiment 1 of the present disclosure, the pitch-adjusting assembly further comprises an anti-falling piece set on one of the two adjusting parts 50, while the locking part passes through the other one of the two adjusting parts 50 and the fixing structure 10, and then the locking part is in thread connection with the anti-falling piece. In some implementations, the anti-falling piece may include a nut (e.g., an anti-loosening nut), which is in thread connection with thread portion of the locking part when it's fully assembled.

### Embodiment 2

It should be noted that, in Embodiment 2 of the present disclosure, the rotational resistance between the adjusting part 50 and the rotating main body 30 is used as a locking friction force for the display to hover at a desired position.

It should be noted that, in the embodiments of the present disclosure, the rotational resistance between the rotating main body 30 and the fixing structure 10 refers to the frictional resistance generated between the rotating main body 30 and the fixing structure 10 when the rotating main body 30 rotates relative to the fixing structure 10, specifically, the rolling friction force generated between the inner ring and the outer ring of the one-way bearing; the rotational resistance between the adjusting part 50 and the rotating main body 30 refers to the frictional resistance generated between the adjusting part 50 and the rotating main body 30 when the adjusting part 50 rotates relative to the rotating main body 30, specifically, the sliding friction force generated between the ribbed threads 51 and the grooves 31.

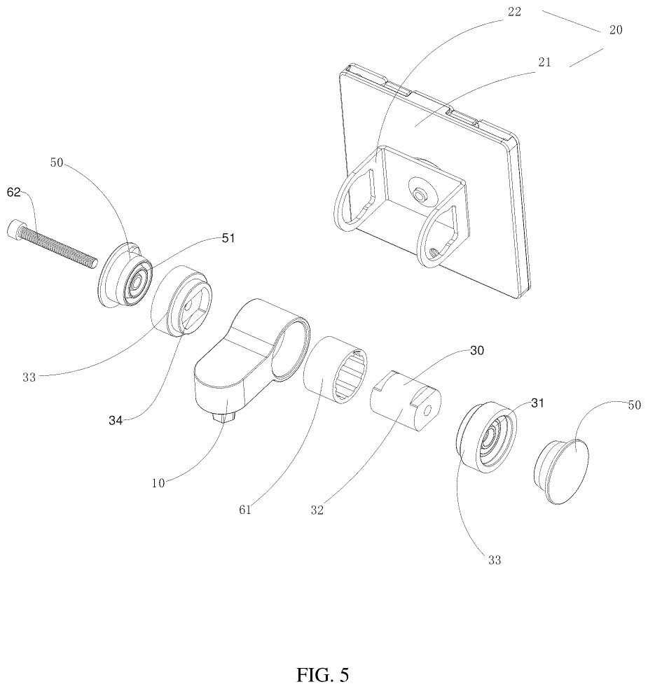

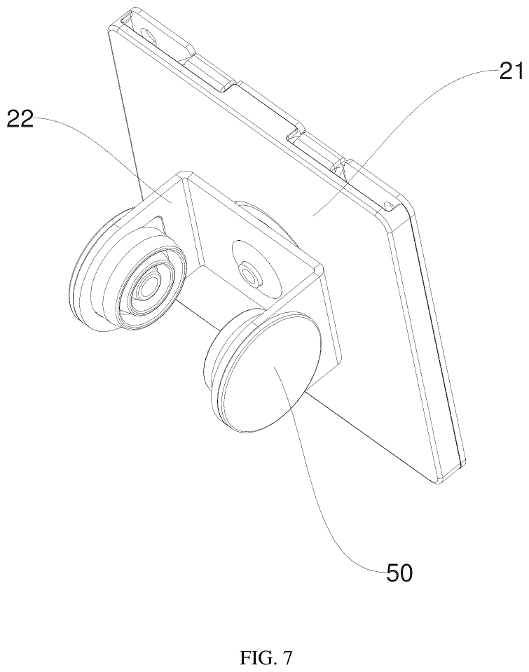

As shown in FIG. 5 to FIG. 8, the Embodiment 2 of the present disclosure provides a pitch-adjusting assembly for display arms. The pitch-adjusting assembly for display arms comprises a fixing structure 10, a mounting structure 20, and an adjusting structure.

In some implementations, the fixing structure 10 is configured to be disposed on a support base; the mounting structure 20 is configured for mounting a display; the adjusting structure penetrates the fixing structure 10, and the adjusting structure comprising a rotating main body 30 and an adjusting part 50 rotatably arranged relative to the rotating main body 30, the adjusting part 50 is connected with the mounting structure 20, the rotating main body 30 drives the mounting structure 20 to rotate unidirectionally from bottom to top relative to the fixed structure 10, the rotational resistance between the rotating main body 30 and the fixing structure 10 is smaller than the rotational resistance between the adjusting part 50 and the rotating main body 30, so that the mounting structure 20 rotates in a unidirectional and effortless manner from bottom to top.

In the above technical scheme, when the display is hung on the mounting structure 20, the gravity of the display can generate a downward moment of force as shown in FIG. 5 (e.g., “clockwise downward” when viewing from right side towards left side of the figure). Since the rotational resistance between the adjusting part 50 and the rotating main body 30 is greater than the rotational resistance between the rotating main body 30 and the fixing structure 10, when the display needs to be adjusted upward in the anticlockwise direction in FIG. 5 (i.e. make the display rotate from bottom to top relative to the fixing structure 10), the rotating main body 30 can directly be made to rotate anticlockwise, so that the rotating main body 30 drives the display to rotate from bottom to top relative to the fixing structure 10 through the adjusting part 50. In this way, the external force applied by users only needs to overcome the rotational resistance between the rotating main body 30 and the fixing structure 10 and the gravity of the display to adjust the pitch angle of the display; and the great friction force between the rotating main body 30 and the adjusting part 50 does not need to be overcome, so that users can adjust the position of the display from bottom to top more effortlessly, improving user experience.

In some implementations, in Embodiment 2 of the present disclosure, when the display is hung on the mounting structure 20, the gravity of the display can generate a clockwise downward moment of force as shown in FIG. 5, since the rotating main body 30 drives the mounting structure 20 to rotate in a unidirectional direction from bottom to top relative to the fixing structure 10, the rotating main body 30 does not rotate clockwise relative to the fixing structure 10 in FIG. 5, and when the display needs to be adjusted clockwise downward, the adjusting parts 50 can be screwed to overcome the rotational resistance between the adjusting parts 50 and the rotating main body 30, i.e. make the adjusting parts 50 rotate clockwise relative to the rotating main body 30 to drive the mounting structure 20 and the display on the mounting structure 20 to rotate clockwise.

In some implementations, in the embodiments of the present disclosure, there are two adjusting parts 50, which are respectively located on two sides of the fixing structure 10, and the two adjusting parts 50 are both connected to the mounting structure 20.

In some implementations, as shown in FIG. 5, in Embodiment 2 of the present disclosure, the fixing structure 10 is provided with an assembly through hole, the pitch-adjusting assembly further comprises a unidirectional effort-saving component 61 located in the assembly through hole, and the unidirectional effort-saving component 61 comprises an outer shaft sleeve and an inner shaft sleeve. Wherein, the outer shaft sleeve is connected with the fixing structure 10 or the outer shaft sleeve is in interference fit with the assembly through hole; the inner shaft sleeve is inside the outer shaft sleeve, the inner shaft sleeve is located on the outer periphery of the rotating body 30 and is connected with the rotating body 30, and the inner shaft sleeve only rotates unidirectionally relative to the outer shaft sleeve along the circumferential direction of the outer shaft sleeve. In this way, unidirectional rotation of the rotating main body 30 can be realized, thereby achieving the purpose of effortless adjustment of the position of the display.

In some implementations, in Embodiment 2 of the present disclosure, the unidirectional effort-saving component 61 is a one-way bearing, the inner ring of the one-way bearing forms the inner shaft sleeve, and an outer ring of the one-way bearing forms the outer shaft sleeve.

In some implementations, in Embodiment 2 of the present disclosure, the outer ring of the one-way bearing is bonded with the inner wall of the assembling through hole of the fixing structure 10 by glue.

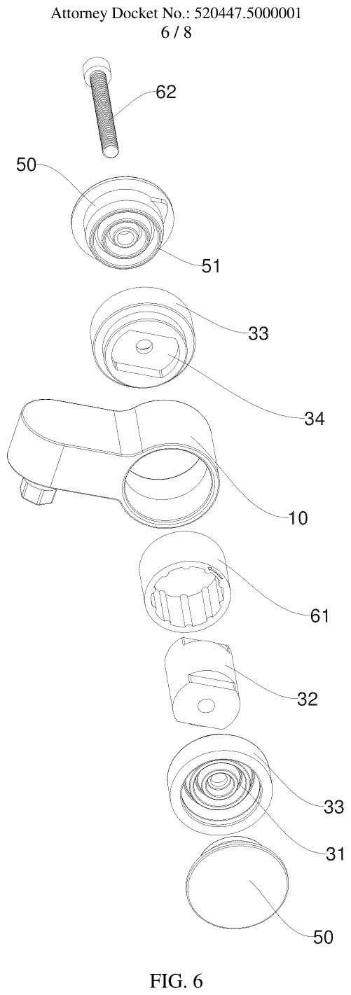

In some implementations, as shown in FIGS. 5 and 6, in Embodiment 2 of the present disclosure, the adjusting part 50 is provided with one or more rounds of threads (e.g., ribbed threads 51), the ribbed threads 51 extend in the circumferential direction of the rotating main body 30, and from the rotating main body 30 to the adjusting part 50, the widths of the ribbed threads 51 gradually increase; the rotating main body 30 is provided with grooves 31 matched with the ribbed threads 51, the grooves 31 gradually increase in width from the rotating main body 30 to the adjusting part 50, and the side walls of the ribbed threads 51 are abutted against the inner walls of the grooves 31.

Through the above arrangement, on the one hand, the adjusting part 50 and the rotating main body 30 can rotate relatively, and on the other hand, the friction force required for the display to hover can be generated between the side walls of the ribbed threads 51 and the inner walls of the grooves 31.

In some implementations, as shown in FIG. 6, in Embodiment 2 of the present disclosure, the ribbed threads 51 are annular structure extending around the axis of the rotating main body 30; and the ribbed threads 51 are disposed along the adjusting part 50 in a radial intervals formation, and the rotating main body 30 is provided with a plurality of grooves 31 matched with the plurality of ribbed threads 51.

Through the above arrangement, the friction force between the adjusting part 50 and the rotating main body 30 can be increased, thereby providing a great friction force for the display to hover and ensuring the stability of the display hovering at the desired position.

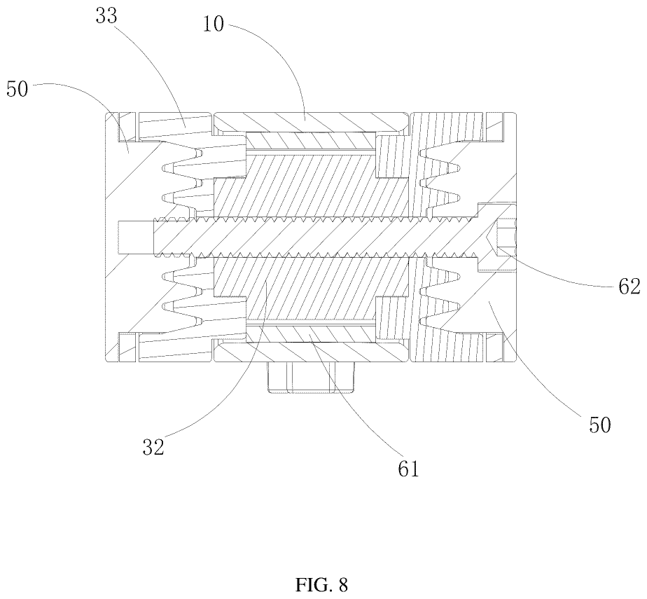

In some implementations, as shown in FIGS. 6 and 8, in Embodiment 2 of the present disclosure, the rotating main body 30 comprises a rotating shaft 32 and a rotating part 33 located at one end at least, of the rotating shaft 32, a rotational resistance exists between the adjusting part 50 and the rotating part 33, a rotation stopping groove 34 is set on the rotating part 33, and one end or the ends of the rotating shaft 32 is/are in anti-rotating fit with the rotation stopping groove 34, so that the rotating part 33 can drive the rotating shaft 32 to rotate.

Through the above arrangement, when the display needs to be adjusted upward in the anticlockwise direction in FIG. 5 (i.e. make the display rotate from bottom to top relative to the fixing structure 10), the rotating part 33 can directly be screwed, driving the rotating shaft 32 to rotate unidirectionally, so that the display can be adjusted from bottom to top; when the display needs to be adjusted downward in the clockwise direction in FIG. 5 (i.e. make the display rotate from top to bottom relative to the fixing structure 10), by overcoming the rotational resistance between the adjusting part 50 and the rotating part 33, the adjusting part 50 can rotate clockwise relative to the rotating part 33, so that the display can be adjusted from top to bottom.

In some implementations, in Embodiment 2 of the present disclosure, the rotating part 33 comprises two shaft segments arranged in a ladder manner, and there is a step surface between the two shaft segments, one of the two shaft segments penetrates through the assembly through hole of the fixing structure 10, the other one of the two shaft segments is positioned on one side of the fixing structure 10, and the step surface between the two shaft segments is abutted against the fixing structure 10 so as to realize the axial limitation of the rotating main body 30.

In some implementations, as shown in FIG. 5, in Embodiment 2 of the present disclosure, the mounting structure 20 comprises a panel 21 and a connecting component 22. Wherein, the panel is used for mounting a display; the connecting component 22 is used for connecting the panel 21 and the adjusting part 50, the connecting component 22 is provided with a rotation stopping hole, and the adjusting part 50 is in anti-rotating fit with the rotation stopping hole.

Through the above arrangement, the adjusting part 50 can drive the connecting component 22 to rotate when the adjusting part 50 is rotating, so that the display can be driven to rotate by the connected panel 21.

In some implementations, as shown, in Embodiment 2 of the present disclosure, the pitch-adjusting assembly further comprises a locking part 62 penetrating the adjusting part 50 and the rotating main body 30, and the locking part 62 is used for locking the adjusting part 50 on the rotating main body 30.

Through the above arrangement, the locking force provided by the locking part 62 can squeeze and abut the side walls of the ribbed threads 51 with the inner walls of the grooves 31, so that the friction force required for the display to hover is generated between the side walls of the ribbed threads 51 and the inner walls of the grooves 31.

In some implementations, in Embodiment 2 of the present disclosure, the locking part 62 passes through one adjusting part 50 and the rotating main body 30 and in thread connection with the other adjusting part 50 to pull the two adjusting parts 50 together toward the rotating main body 30, so that the locking part 62 can squeeze and abut the side walls of the ribbed threads 51 on the adjusting parts 50 with the inner walls of the grooves 31 on the rotating main body 30, thus a great friction is generated, thereby counteracting the moment of force generated by gravity to make the display to hover at a desired pitch angle position.

The embodiments of the present disclosure provide a display arm, comprising a support base and a pitch-adjusting assembly for display arms, which is set on the support base. The display arm mentioned above has all the advantages of the pitch-adjusting assembly for display arms mentioned above, which will not be repeated herein.

In various embodiments, the present disclosure describes a pitch-adjusting assembly for display arms, comprising: a fixing structure configured to be disposed on a support base; a mounting structure configured for mounting a display; and an adjusting structure penetrating the fixing structure, the adjustment structure comprising: an adjusting part, one end of the adjusting part being connected to the mounting structure, and the other end of the adjusting part being rotationally connected to the fixing structure, an elastic part disposed at the periphery of the adjusting part, one end of the elastic part being clamped or connected with the fixing structure, and the other end of the elastic part being clamped or connected with the adjusting part, and wherein: when the adjusting part drives the mounting structure to rotate from top to bottom relative to the fixing structure, a first torque generated by the elastic part counteracts an overturning force generated by the display due to gravity to provide rotation resistance to the display; and when the adjusting part drives the mounting structure to rotate from bottom to top relative to the fixing structure, a second torque released by the elastic part counteracts the overturning force generated by the display due to gravity to provide rotary power for the display.

In some implementations, alternatively, optionally, and/or additional to any implementation/embodiment or any combination of implementations/embodiments in the present disclosure, at least one side of the fixing structure is provided with an assembly hole, the elastic part is a spiral torsion spring, and the spiral torsion spring is located inside the assembly hole.

In some implementations, alternatively, optionally, and/or additional to any implementation/embodiment or any combination of implementations/embodiments in the present disclosure, a first clamping groove is set on the circumferential inner wall of the assembly hole, a second clamping groove is set on the circumferential outer wall of the adjusting part, the outer end of the spiral torsion spring is provided with a first clamping piece, which is in clamping fit with the first clamping groove, and the inner end of the spiral torsion spring is provided with a second clamping piece, which is in clamping fit with the second clamping groove.

In various embodiments, the present disclosure describes a pitch-adjusting assembly for display arms, comprising: a fixing structure configured to be disposed on a support base; a mounting structure configured for mounting a display; and an adjusting structure penetrating through the fixing structure, and the adjusting structure comprising a rotating main body and an adjusting part rotatably arranged relative to the rotating main body, wherein: the adjusting part is connected with the mounting structure, the rotating main body drives the mounting structure to rotate unidirectionally from bottom to top relative to the fixed structure, and a first rotational resistance between the rotating main body and the fixing structure is smaller than a second rotational resistance between the adjusting part and the rotating main body, so that the mounting structure rotates in a unidirectional and effortless manner from bottom to top.

In some implementations, alternatively, optionally, and/or additional to any implementation/embodiment or any combination of implementations/embodiments in the present disclosure, the fixing structure comprises an assembly through hole, the pitch-adjusting assembly further comprises a unidirectional effort-saving component disposed in the assembly through hole, and the unidirectional effort-saving component comprises: an outer shaft sleeve connected with the fixing structure or the outer shaft sleeve is in interference fit with the assembly through hole, the inner shaft sleeve is inside the outer shaft sleeve, the inner one is also located at the outer periphery of the rotating main body and is meanwhile connected to the rotating main body, and the inner shaft sleeve only rotates unidirectionally in the circumferential direction of the outer shaft sleeve relative to the outer shaft sleeve.

In some implementations, alternatively, optionally, and/or additional to any implementation/embodiment or any combination of implementations/embodiments in the present disclosure, the adjusting part comprises ribbed threads; the ribbed threads extend in the circumferential direction of the rotating main body, and from the rotating main body to the adjusting part; the widths of the ribbed threads gradually increase; the rotating main body comprises grooves matched with the ribbed threads; the grooves gradually increase in width from the rotating main body to the adjusting part; and the side walls of the ribbed threads are abutted against the inner walls of the grooves.

In some implementations, alternatively, optionally, and/or additional to any implementation/embodiment or any combination of implementations/embodiments in the present disclosure, the ribbed threads are annular structure extending around the axis of the rotating main body; and/or the ribbed threads are a plurality of ribbed threads disposed along the adjusting part in a radial interval formation, and the rotating main body is provided with a plurality of grooves matched with the plurality of ribbed threads.

In some implementations, alternatively, optionally, and/or additional to any implementation/embodiment or any combination of implementations/embodiments in the present disclosure, the rotating main body comprises a rotating shaft and a rotating part disposed at at least one end of the rotating shaft, a rotational resistance exists between the adjusting part and the rotating part, a rotation stopping groove is set on the rotating part, and at least one end of the rotating shaft is in anti-rotating fit with the rotation stopping groove, so that the rotating part drives the rotating shaft to rotate.

In some implementations, alternatively, optionally, and/or additional to any implementation/embodiment or any combination of implementations/embodiments in the present disclosure, the mounting structure comprises: a panel for mounting a display, and a connecting component, used for connecting the panel and the adjusting part, wherein the connecting component is provided with a rotation stopping hole, and the adjusting part is in anti-rotating fit with the rotation stopping hole; and/or the pitch-adjusting assembly further comprises a locking part penetrating the adjusting part and the rotating main body, and the locking part is used for locking the adjusting part on the rotating main body.

In various embodiments, the present disclosure describes a display arm, comprising: a support base; and the pitch-adjusting assembly according to any implementation/embodiment or any combination of implementations/embodiments in the present disclosure, and/or the pitch-adjusting assembly is set/disposed on the support base.

The present disclosure may also include the following embodiments.

1. A pitch-adjusting assembly for display arms' use, characterized by comprising a fixing structure (10) configured to be disposed on a support base, a mounting structure (20) configured for mounting a display, and an adjusting structure penetrating the fixing structure (10), the adjustment structure comprising: an adjusting part (50), whose one end is connected to the mounting structure (20), and the other end of the adjusting part (50) is rotationally connected to the fixing structure (10); an elastic part (63), located at the periphery of the adjusting part (50), one end of the elastic part (63) being clamped or connected with the fixing structure (10), and the other end of the elastic part (63) being clamped or connected with the adjusting part (50); wherein, when the adjusting part (50) drives the mounting structure (20) to rotate from top to bottom relative to the fixing structure (10), the torque generated by the elastic part (63) counteracts the overturning force generated by the display due to gravity to provide rotation resistance to the display; when the adjusting part (50) drives the mounting structure (20) to rotate from bottom to top relative to the fixing structure (10), the torque released by the elastic part (63) counteracts the overturning force generated by the display due to gravity to provide rotary power for the display.

2. The pitch-adjusting assembly for display arms' use of 1, characterized in that at least one side of the fixing structure (10) is provided with an assembly hole (11), the elastic part (63) is a spiral torsion spring, and the spiral torsion spring is located inside the assembly hole (11).

3. The pitch-adjusting assembly for display arms' use of 2, characterized in that a first clamping groove (12) is set on the circumferential inner wall of the assembly hole (11), a second clamping groove (52) is set on the circumferential outer wall of the adjusting part (50), the outer end of the spiral torsion spring is provided with a first clamping piece (64), which is in clamping fit with the first clamping groove (12), and the inner end of the spiral torsion spring is provided with a second clamping piece (65), which is in clamping fit with the second clamping groove (52).

4. A pitch-adjusting assembly for display arms' use, comprising: a fixing structure (10) configured to be disposed on the support base; a mounting structure (20) configured for mounting a display; the adjusting structure penetrates through the fixing structure (10), the adjusting structure comprises a rotating main body (30) and an adjusting part (50) rotatably arranged relative to the rotating main body (30), the adjusting part (50) is connected with the mounting structure (20), the rotating main body (30) drives the mounting structure (20) to rotate unidirectionally from bottom to top relative to the fixed structure (10), the rotational resistance between the rotating main body (30) and the fixing structure (10) is smaller than the rotational resistance between the adjusting part (50) and the rotating main body (30), so that the mounting structure (20) rotates in a unidirectional and effortless manner from bottom to top.

5. The pitch-adjusting assembly for display arms' use of 4, characterized in that the fixing structure (10) is provided with an assembly through hole, the pitch-adjusting assembly further comprises a unidirectional effort-saving component (61) located in the assembly through hole, and the unidirectional effort-saving component (61) comprises: an outer shaft sleeve connected with the fixing structure (10) or the outer shaft sleeve is in interference fit with the assembly through hole; the inner shaft sleeve is inside the outer shaft sleeve, the inner one is also located at the outer periphery of the rotating main body (30) and it is meanwhile connected to it, and the inner shaft sleeve only rotates unidirectionally in the circumferential direction of the outer shaft sleeve relative to the outer shaft sleeve.

6. The pitch-adjusting assembly for display arms' use of 4, characterized in that the adjusting part (50) is provided with ribbed threads (51), the ribbed threads (51) extend in the circumferential direction of the rotating main body (30), and from the rotating main body (30) to the adjusting part (50), the widths of the ribbed threads (51) are gradually increases; the rotating main body (30) is provided with grooves (31) matched with the ribbed threads (51), the grooves (31) gradually increase in width from the rotating main body (30) to the adjusting part (50), and the side walls of the ribbed threads (51) are abutted against the inner walls of the grooves (31).

7. The pitch-adjusting assembly for display arms' use of 6, characterized in that the ribbed threads (51) are annular structure extending around the axis of the rotating main body (30); and/or, it can be a plurality of ribbed threads (51) disposed along the adjusting part (50) in a radial intervals formation, and the rotating main body (30) is provided with a plurality of grooves (31) matched with the plurality of ribbed threads (51).

8. The pitch-adjusting assembly for display arms' use according to any one of claim 4 to claim 7, characterized in that the rotating main body (30) comprises a rotating shaft (32) and a rotating part (33) located at one end at least, of the rotating shaft (32), a rotational resistance exists between the adjusting part (50) and the rotating part (33), a rotation stopping groove (34) is set on the rotating part (33), and one end or the ends of the rotating shaft (32) is/are in anti-rotating fit with the rotation stopping groove (34), so that the rotating part (33) can drive the rotating shaft (32) to rotate.

9. The pitch-adjusting assembly for display arms' use according to any one of 4 to 7, characterized in that the mounting structure (20) comprises: a panel (21) for mounting a display; a connecting component (22), used for connecting the panel (21) and the adjusting part (50), the connecting component (22) is provided with a rotation stopping hole, and the adjusting part (50) is in anti-rotating fit with the rotation stopping hole; or, the pitch-adjusting assembly further comprises a locking part (62) penetrating the adjusting part (50) and the rotating main body (30), and the locking part (62) is used for locking the adjusting part (50) on the rotating main body (30).

10. A display arm, characterized by comprising a support base and the pitch-adjusting assembly for display arms' use according to any one of 1 to 9, which is set on the support base.

From the above description, it can be seen that the embodiments of the present disclosure realize at least one of the following technical effects.

When the adjusting part drives the mounting structure to rotate from top to bottom relative to the fixing structure, the torque generated by the elastic part counteracts the overturning force generated by the display due to gravity to provide rotation resistance for the display; in this way, the torque generated by the elastic part can prevent the display from keeping moving downwards, in other words, the locking friction force between the adjusting part and the fixing structure, and the torque force generated by the elastic part are jointly used for preventing the display from moving, so that the position of the display can keep at the desired pitch angle after adjustment without requiring a great locking friction force.

When the adjusting part drives the mounting structure to rotate from bottom to top relative to the fixing structure, the torque released by the elastic part counteracts the overturning force generated by the display due to gravity to provide rotary power for the display, so that users can adjust the display upwards without overcoming great friction force and gravity, and also adjust the pitch angle of the display more effortlessly, improving user experience.

The foregoing descriptions are only preferred embodiments used for understanding the present disclosure, and are not intended to limit the claims concern this invention. And various changes and variations may be made to the present disclosure for those skilled in the art. Any modifications, equivalent substitutions, improvements and the like made within the spirit and principles of the present disclosure shall be included within the protection scope of the present disclosure.

While the particular disclosure has been described with reference to illustrative embodiments, this description is not meant to be limiting. Various modifications of the illustrative embodiments and additional embodiments of the disclosure will be apparent to one of ordinary skill in the art from this description. Those skilled in the art will readily recognize that these and various other modifications can be made to the exemplary embodiments, illustrated and described herein, without departing from the spirit and scope of the present disclosure. It is therefore contemplated that the appended claims will cover any such modifications and alternate embodiments. Certain proportions within the illustrations may be exaggerated, while other proportions may be minimized. Accordingly, the disclosure and the figures are to be regarded as illustrative rather than restrictive.

What is claimed is:

1. A pitch-adjusting assembly for display arms, comprising:
a fixing structure configured to be disposed on a support base;
a mounting structure configured for mounting a display; and
an adjusting structure penetrating the fixing structure, the adjustment structure comprising:
an adjusting part, one end of the adjusting part being connected to the mounting structure, and the other end of the adjusting part being rotationally connected to the fixing structure,
an elastic part disposed at the periphery of the adjusting part, one end of the elastic part being clamped or connected with the fixing structure, and the other end of the elastic part being clamped or connected with the adjusting part, and
wherein:
when the adjusting part drives the mounting structure to rotate from top to bottom relative to the fixing structure, a first torque generated by the elastic part counteracts an overturning force generated by the display due to gravity to provide rotation resistance to the display; and
when the adjusting part drives the mounting structure to rotate from bottom to top relative to the fixing structure, a second torque released by the elastic part counteracts the overturning force generated by the display due to gravity to provide rotary power for the display.

2. The pitch-adjusting assembly according to claim 1, wherein:
at least one side of the fixing structure is provided with an assembly hole,
the elastic part is a spiral torsion spring, and
the spiral torsion spring is located inside the assembly hole.

3. The pitch-adjusting assembly according to claim 2, wherein:
a first clamping groove is set on the circumferential inner wall of the assembly hole,
a second clamping groove is set on the circumferential outer wall of the adjusting part,
the outer end of the spiral torsion spring is provided with a first clamping piece, which is in clamping fit with the first clamping groove, and
the inner end of the spiral torsion spring is provided with a second clamping piece, which is in clamping fit with the second clamping groove.

4. A pitch-adjusting assembly for display arms, comprising:
a fixing structure configured to be disposed on a support base;
a mounting structure configured for mounting a display; and
an adjusting structure penetrating through the fixing structure, and the adjusting structure comprising a rotating main body and an adjusting part rotatably arranged relative to the rotating main body, wherein:
the adjusting part is connected with the mounting structure,
the rotating main body drives the mounting structure to rotate unidirectionally from bottom to top relative to the fixed structure, and
a first rotational resistance between the rotating main body and the fixing structure is smaller than a second rotational resistance between the adjusting part and the rotating main body, so that the mounting structure rotates in a unidirectional and effortless manner from bottom to top.

5. The pitch-adjusting assembly according to claim 4, wherein:
the fixing structure comprises an assembly through hole,
the pitch-adjusting assembly further comprises a unidirectional effort-saving component disposed in the assembly through hole, and
the unidirectional effort-saving component comprises:
an outer shaft sleeve connected with the fixing structure or the outer shaft sleeve is in interference fit with the assembly through hole,
the inner shaft sleeve is inside the outer shaft sleeve, the inner one is also located at the outer periphery of the rotating main body and is meanwhile connected to the rotating main body, and
the inner shaft sleeve only rotates unidirectionally in the circumferential direction of the outer shaft sleeve relative to the outer shaft sleeve.

6. The pitch-adjusting assembly according to claim 4, wherein:
the adjusting part comprises ribbed threads;
the ribbed threads extend in the circumferential direction of the rotating main body, and from the rotating main body to the adjusting part;
the widths of the ribbed threads gradually increase;
the rotating main body comprises grooves matched with the ribbed threads;
the grooves gradually increase in width from the rotating main body to the adjusting part; and
the side walls of the ribbed threads are abutted against the inner walls of the grooves.

7. The pitch-adjusting assembly according to claim 6, wherein:
the ribbed threads are annular structure extending around the axis of the rotating main body; or
the ribbed threads are a plurality of ribbed threads disposed along the adjusting part in a radial interval formation, and the rotating main body is provided with a plurality of grooves matched with the plurality of ribbed threads.

8. The pitch-adjusting assembly according to claim 4, wherein:
the rotating main body comprises a rotating shaft and a rotating part disposed at at least one end of the rotating shaft,
a rotational resistance exists between the adjusting part and the rotating part,
a rotation stopping groove is set on the rotating part, and
at least one end of the rotating shaft is in anti-rotating fit with the rotation stopping groove, so that the rotating part drives the rotating shaft to rotate.

9. The pitch-adjusting assembly according to claim 4, wherein:
the mounting structure comprises:
a panel for mounting a display, and
a connecting component, used for connecting the panel and the adjusting part, wherein the connecting component is provided with a rotation stopping hole, and the adjusting part is in anti-rotating fit with the rotation stopping hole; or
the pitch-adjusting assembly further comprises a locking part penetrating the adjusting part and the rotating main body, and the locking part is used for locking the adjusting part on the rotating main body.

10. A display arm, comprising:
a support base; and
the pitch-adjusting assembly according to claim 1, which is disposed on the support base.

11. A display arm, comprising:
a support base; and
the pitch-adjusting assembly according to claim 2, which is disposed on the support base.

12. A display arm, comprising:
a support base; and
the pitch-adjusting assembly according to claim 3, which is disposed on the support base.

13. A display arm, comprising:
a support base; and
the pitch-adjusting assembly according to claim 4, which is disposed on the support base.

14. A display arm, comprising:
a support base; and
the pitch-adjusting assembly according to claim 5, which is disposed on the support base.

15. A display arm, comprising:
a support base; and
the pitch-adjusting assembly according to claim 6, which is disposed on the support base.

16. A display arm, comprising:
a support base; and
the pitch-adjusting assembly according to claim 7, which is disposed on the support base.

17. A display arm, comprising:
a support base; and
the pitch-adjusting assembly according to claim 8, which is disposed on the support base.

18. A display arm, comprising:
a support base; and
the pitch-adjusting assembly according to claim 9, which is disposed on the support base.
